(19) United States
(12) Patent Application Publication
(10) Pub. No.: US 2023/0343017 A1
(43) Pub. Date: Oct. 26, 2023

(54) VIRTUAL VIEWPORT GENERATION METHOD AND APPARATUS, RENDERING AND DECODING METHODS AND APPARATUSES, DEVICE AND STORAGE MEDIUM

(71) Applicant: GUANGDONG OPPO MOBILE TELECOMMUNICATIONS CORP., LTD., Dongguan (CN)

(72) Inventors: You YANG, Dongguan (CN); Yongquan SU, Dongguan (CN); Qiong LIU, Dongguan (CN); Kejun WU, Dongguan (CN); Ruichen ZHANG, Dongguan (CN)

(21) Appl. No.: 18/216,857

(22) Filed: Jun. 30, 2023

Related U.S. Application Data
(63) Continuation of application No. PCT/CN2020/141508, filed on Dec. 30, 2020.

(51) Int. Cl. G06T 15/04; G06T 15/80; G06T 7/11; G06T 7/50; G06V 10/762

(52) U.S. Cl. CPC G06T 15/04; G06T 15/80; G06T 7/11; G06T 7/50; G06V 10/762

(57) ABSTRACT

A method for generating a virtual view includes generating an initial visibility map of a target view according to a depth map of a source view; segmenting the initial visibility map to obtain segmentation regions; identifying target pixels in the segmentation region according to a quantity relationship of two categories of pixels in the segmentation region of the initial visibility map; updating pixel values of the target pixels in the segmentation region of the initial visibility map to obtain a first visibility map of the target view; and processing the first visibility map of the target view to obtain a target texture map of the target view.

### CROSS-REFERENCE TO RELATED APPLICATION

This application is a continuation of International Application No. PCT/CN2020/141508 filed on Dec. 30, 2020, the disclosure of which is hereby incorporated by reference in its entirety.

### BACKGROUND

Most of users prefer to watch immersive video content (such as virtual reality content, three-dimensional content, 180-degree content or 360-degree content), and the immersive video content can provide an immersive experience for the viewer. In addition, these users may like to watch content generated by a computer in an immersive format, such as game video or animation.

However, at the encoding end, since some errors exist in depth values of some pixels in a depth map, and a large number of parameters are used for performing compression encoding on the depth map, the compression distortion is very serious. As a result, at the decoding end, the quality of the depth map recovered by decoding will be greatly reduced, which will lead to obvious noise in a generated depth map of a target view.

### SUMMARY

Embodiments of the disclosure relates to the computer vision technology, and relates to but is not limited to, a method and device for generating a virtual view, a rendering method, a decoding method, a rendering device, a decoding device, an apparatus and a storage medium.

In view of the above, embodiments of the disclosure provide a method and device for generating a virtual view, a rendering method, a decoding method, a rendering device, a decoding device, an apparatus and a storage medium, which can reduce large noise regions of a target texture map of the target view, so that noises of the target texture map are obviously reduced. The method and device for generating a virtual view, the rendering method, the decoding method, the rendering device, the decoding device, the apparatus and the storage medium provided by the embodiment of the disclosure are realized as follows.

Embodiments of the disclosure provide a method for generating a virtual view. The method for generating a virtual view includes generating an initial visibility map of a target view according to a depth map of a source view; segmenting the initial visibility map to obtain segmentation regions; identifying target pixels in the segmentation region according to a quantity relationship of two categories of pixels in the segmentation region of the initial visibility map; updating pixel values of the target pixels in the segmentation region of the initial visibility map to obtain a first visibility map of the target view; and processing the first visibility map of the target view to obtain a target texture map of the target view.

Embodiments of the disclosure provide a rendering method. The rendering method includes performing pruned view reconstruction on an atlas of a depth map of a source view to obtain the depth map of the source view; performing operations in the method for generating a virtual view on the depth map of the source view to obtain a target texture map of a target view; and generating a target viewport of the target view according to the target texture map of the target view.

Embodiments of the disclosure provide a decoding method. The decoding method includes decoding input bitstream to obtain an atlas of a depth map of a source view; performing pruned view reconstruction on the atlas of the depth map of the source view to obtain the depth map of the source view; performing operations in the method for generating a virtual view on the depth map of the source view to obtain a target texture map of a target view; and generating a target viewport of the target view according to the target texture map of the target view.

Embodiments of the disclosure provide a device for generating a virtual view including a visibility map generating module, a region segmenting module, an identifying module, an updating module, and a target texture map obtaining module. The visibility map generating module is configured to generate an initial visibility map of a target view according to a depth map of a source view. The region segmenting module is configured to segment the initial visibility map to obtain segmentation regions. The identifying module is configured to identify target pixels in the segmentation region according to a quantity relationship of two categories of pixels in the segmentation region of the initial visibility map. The updating module is configured to update pixel values of the target pixels in the segmentation region of the initial visibility map to obtain a first visibility map of the target view. The target texture map obtaining module is configured to process the first visibility map of the target view to obtain a target texture map of the target view.

Embodiments of the disclosure provide a rendering device including a pruned view reconstruction module, a virtual view generating module and a target view synthesis module. The pruned view reconstruction module is configured to perform pruned view reconstruction on an atlas of a depth map of a source view to obtain the depth map of the source view. The virtual view generating module is configured to perform operations in the method for generating a virtual view on the depth map of the source view to obtain a target texture map of a target view. The target view synthesis module is configured to generate a target viewport of the target view according to the target texture map of the target view.

Embodiments of the disclosure provide a decoding device including a decoding module, a pruned view reconstruction module, a virtual view generating module and a target view synthesis module. The decoding module is configured to decode input bitstream to obtain an atlas of a depth map of a source view. The pruned view reconstruction module is configured to perform pruned view reconstruction on the atlas of the depth map of the source view to obtain the depth map of the source view. The virtual view generating module is configured to perform operations in the method for generating a virtual view on the depth map of the source view to obtain a target texture map of a target view. The target view synthesis module is configured to generate a target viewport of the target view according to the target texture map of the target view.

Embodiments of the disclosure provide a View Weighting Synthesizer (VWS) configured to implement the method for generating a virtual view. Embodiments of the disclosure provide a rendering device configured to implement the rendering method. Embodiments of the disclosure provide a decoder configured to implement the decoding method. Embodiments of the disclosure provide an electronic device including a memory and a processor, where the memory is configured to store computer programs executable on the processor, and the processor is configured to implement the method for generating a virtual view when executing the programs. Embodiments of the disclosure provide a computer-readable storage medium having stored thereon computer programs that, when executed by a processor, cause the processor to implement the method for generating a virtual view.

### BRIEF DESCRIPTION OF THE DRAWINGS

The accompanying drawings, which are incorporated in and constitute a part of this specification, illustrate embodiments consistent with the disclosure and, together with the description, serve to explain the technical solutions in the embodiments of the disclosure.

FIG. 1 is a schematic diagram of a system architecture to which embodiments of the present disclosure may apply.

FIG. 2 is a schematic diagram of a VWS.

FIG. 3 is a schematic diagram of a calculation flow of weights of pixels that are not pruned.

FIG. 4 is a schematic diagram of a comparison between a depth map obtained by depth estimation and a depth map generated by a VWS.

FIG. 5 is a schematic diagram of a comparison between edges of a depth map generated by a VWS and edges of a texture map generated by the VWS.

FIG. 6 is an implementation flowchart of a method for generating a virtual view according to an embodiment of the disclosure.

FIG. 7 is an implementation flowchart of a method for generating a virtual view according to an embodiment of the disclosure.

FIG. 8 is an implementation flowchart of a method for generating a virtual view according to an embodiment of the disclosure.

FIG. 9 is an implementation flowchart of a method for generating a virtual view according to an embodiment of the disclosure.

FIG. 10 is a schematic flowchart of optimizing a depth map during the view generation by performing superpixel segmentation on a texture map.

FIG. 11 is a schematic diagram of a system architecture introducing superpixel segmentation on a texture map to optimize a depth map during the view generation.

FIG. 12 is a schematic diagram of a comparison between a depth map before optimization and a depth map after optimization.

FIG. 13 is a schematic flowchart of optimizing a depth map during the view generation by performing superpixel segmentation on a depth map according to an embodiment of the present disclosure.

FIG. 14 is a schematic diagram of a system architecture to which embodiments of the present disclosure may apply.

FIG. 15 is a schematic structural diagram of a device for generating a virtual view according to an embodiment of the present disclosure.

FIG. 16 is an effect comparison diagram of depth maps under test sequences in a fencing scene.

FIG. 17 is an effect comparison diagram of texture maps under test sequences in a fencing scene.

FIG. 18 is an effect comparison diagram of depth maps under test sequences in a frog scene.

FIG. 19 is an effect comparison diagram of texture maps under test sequences in a frog scene.

FIG. 20 is a schematic structural diagram of a device for generating a virtual view according to an embodiment of the present disclosure.

FIG. 21 is a schematic structural diagram of a rendering device according to an embodiment of the present disclosure.

FIG. 22 is a schematic structural diagram of a decoding device according to an embodiment of the present disclosure.

FIG. 23 is a schematic diagram of a hardware entity of an electronic device according to an embodiment of the present disclosure.

### DETAILED DESCRIPTION

In order to make the purpose, technical scheme and advantages of the embodiments of the present disclosure clearer, the specific technical scheme of the present disclosure will be further described in detail with reference to the drawings in the embodiments of the present disclosure. The following embodiments are used for illustrating the present disclosure, but are not intended to limit the scope of the present disclosure.

Unless otherwise defined, all technical and scientific terms used herein have the same meaning as commonly understood by those skilled in the technical field of the present disclosure. The terms used herein is only for the purpose of describing the present disclosure, and is not intended to limit the present disclosure.

In the following description, “some embodiments” are referred to, which describe a subset of all possible embodiments, but it is understood that “some embodiments” may be the same subset or different subsets of all possible embodiments, and may be combined with each other without conflict.

It should be noted that, the term “first \second\third” in the present disclosure is used for distinguishing similar objects and not necessarily for describing a specific sequence or sequential order. It is to be understood that the term “first\second\third” may be interchangeable under an appropriate circumstance, so that the embodiments of the present disclosure described herein are, for example, capable of being implemented in a sequence other than those illustrated or described herein.

The system architecture and the service scenario described in the embodiments of the disclosure are for more clearly explaining the technical scheme of the embodiments of the disclosure, which does not constitute a limitation to the technical scheme provided by the embodiments of the present disclosure. Those skilled in the art can appreciate that, the technical scheme provided by the embodiments of the present disclosure is equally applicable to similar technical problems with the evolution of the network architecture and the emergence of new business scenarios.

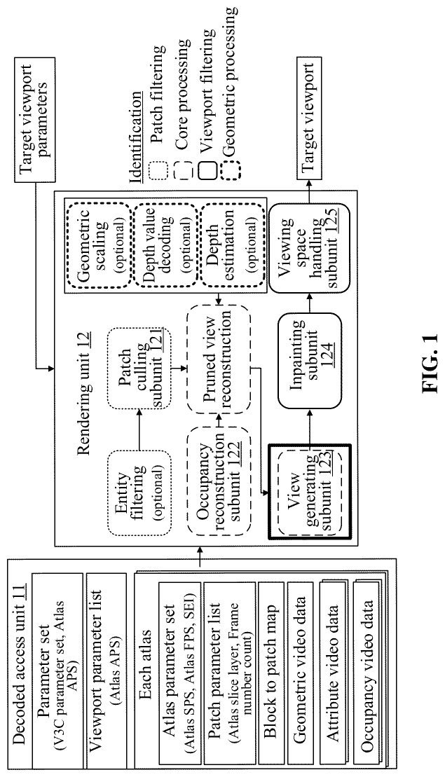

FIG. 1 illustrates a system architecture to which embodiments of the present disclosure may apply, i.e. a system architecture 10 of the Moving Picture Experts Group (MPEG) at the decoding end of the 3 degrees of freedom+(3DoF+) Test Model of Immersive Video (TMIV). As shown in FIG. 1, the system architecture 10 includes: a decoded access unit 11 and a rendering unit 12. The decoded access unit 11 includes various categories of metadata information and atlas information obtained after decoding. The information will then be transmitted to the rendering unit 12 to generate a virtual view. Subunits marked with opt. denote are optional subunits, which are not described herein because they are not mentioned in the technical scheme of the embodiments of the present disclosure. A patch culling subunit 121 of the rendering unit 12 filters patches in the information of the atlas according to the target viewport parameters of the user, and culls the patches that do not overlap with the target viewport of the user, thereby reducing the amount of calculation when generating the virtual view. An occupancy reconstruction subunit 122 of the rendering unit 12 finds out positions of all patches in the viewport according to the information transmitted from the decoded access unit 11, and then pastes each of the filtered patches into a corresponding position to complete the pruned view reconstruction. The view synthesis subunit 123 generates the virtual view, i.e., drawing of the target view, by using the reconstructed pruned view described above. Since the generated virtual view has some hole regions, an inpainting subunit 124 is required to fill the hole regions. Finally, a viewing space handling subunit 125 may cause the viewport to fade smoothly to black.

The VWS is a tool for generating the virtual view used by MPEG in 3DoF+TMIV. The VWS is used in a renderer at the decoding end. Specifically, the VWS is used in a view synthesis stage after a pruned view reconstruction subunit 126.

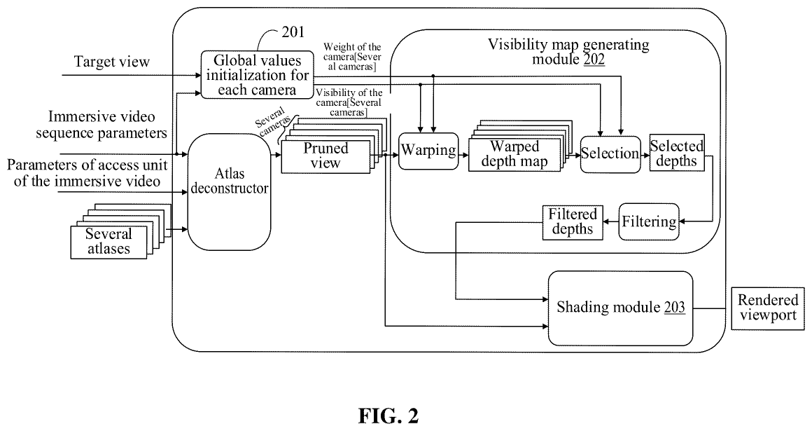

As shown in FIG. 2, in related art, the VWS mainly includes three modules: a weight calculating module 201, a visibility map generating module 202 and a shading module 203. The visibility map generating module 202 is configured to generate a visibility map under the target view. The shading module 203 is configured to shade the generated visibility map under the target view to obtain a texture map under the target view. Since the visibility map generating module 202 and the shading module 203 depend on a weight of the source view with respect to the target view, the weight calculating module 201 is configured to calculate the weight of the source view according to a relationship between the source view and the target view.

1) The related contents of the weight calculating module 201 are described as follows.

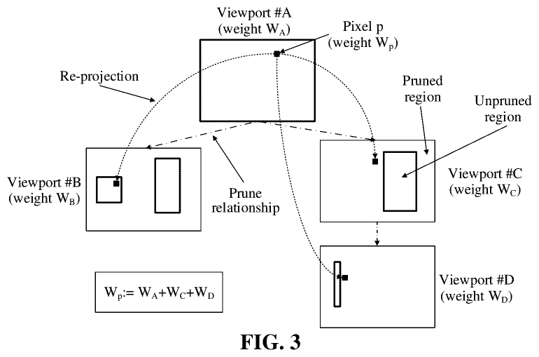

The weight calculating module 201 calculates the weight of the source view based on metadata information of the source view and metadata information of the target view. The weight of the source view is a function of a distance between the source view and the target view. During the process of calculating the visibility map and shading the visibility map, contributions of related pixels to the result are weighted contribution of a view corresponding to the related pixels. When a pruned view is processed, since content of the pruned view is incomplete, the weight calculation of pruned view needs to consider a pruned picture region. The weight calculation is a pixel-wise operation, and the weights are calculated for un-pruned pixels. The weights of pixels are updated during the view generation. As shown in FIG. 3, the weights of the un-pruned pixels are calculated according to the following operations. For an un-pruned pixel p in a view associated with a node N in the pruned view, its initial weight w_{P} of the pixel p is equal to w_{N} (i.e., w_{P}=w_{N}). It should be noted that the initial weight is the weight of the view to which the pixel p belongs, and the weight depends on a distance between the view to which the pixel p belongs and the target view. Then, the weight of the pixel p is updated by the following process including operations of a to c. In operation a, if the pixel p is re-projected into a child node viewport and the re-projected point p corresponds to a pruned pixel in the child node viewport, a new weight of the pixel p is obtained by adding a weight wₒ of the child node viewport into the weight of the pixel p, i.e., wₚ=wₚ+wₒ. It should be noted that the weight of the child viewport depends only on a distance between a view where the child viewport is located and the target view. Then, the above operation is continue to be performed on a grandchild node. In operation b, if the re-projected pixel p does not correspond to the child node viewport, the above operation is recursively performed on the grandchild node. In operation c, if the re-projected pixel p corresponds to an un-pruned pixel in the child node viewport, the weight of the pixel p is unchanged, and the above operation is no longer performed on the grandchild node.

2) The related contents of the visibility map calculating module 202 are described as follows.

The purpose of calculating the visibility map is to obtain a visibility map under the target view according to the reconstructed depth map (i.e., the reconstructed depth map) of the source view. The whole process of the calculating is segmented into three operations: warping, selection and filtering. In the warping operation, the pixels in the depth map of the source view are re-projected to the target view, to generate distorted warped depth map. By performing this operation on the multiple source views, several warped depth maps under the target views are obtained. In the selection operation, the several warped depth maps are merged to generate a relatively complete depth map under the target view, i.e., the visibility map. The selection operation is performed, according to the weight of each source view, by adopting a pixel-wise based majority voting principle. The majority voting principle means that a same pixel position may be projected with multiple depths, and a pixel depth value for the pixel position of the source view is selected as the one corresponding to a most number of projections. Finally, the generated visibility map is filtered by using a median filter to remove isolated noises.

3) The related contents of the shading module 203 are described as follows.

The purpose of this operation is to generate a texture map under the target view. The generation of the texture map under the target view needs to use the filtered visibility map and the reconstructed texture map of the source view. In this process, it is necessary to consider the continuity of pixels in the source view in the visibility map and the weight of the view to which the pixels belong. In order to improve the visual quality of the generated texture content, bilinear filtering is used to process the generated texture map. In addition, in order to avoid the aliasing phenomena, detected pixels from an edge of an object in the texture map of the source view need to be eliminated.

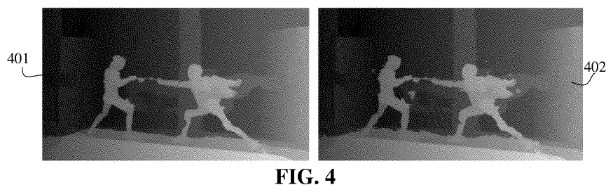

Due to the immature depth acquisition technology and corresponding expensive equipment, the related schemes mostly use the method of texture acquisition before depth estimation to obtain the depth map. However, there will be some errors in depth values calculated by the depth estimation method, which will lead to noises in the estimated depth map. Therefore, generation of a virtual view by using such depth map will inevitably lead to some noises in a generated depth map of a target view. For example, as shown in FIG. 4, the left part 401 of the figure is a depth map obtained by using the depth estimation, and the right part 402 of the figure is a depth map obtained by generating a virtual view using the left part 401 of the figure, i.e., a depth map generated by the VWS. As can be seen from FIG. 4, there is more noises in the right part 402 of the figure.

Before the encoding end compresses the depth map, it is usually necessary to down-sample the depth map to reduce the resolution. The depth map can usually be compressed by using a video coding standard. The depth map subjected to the compression encoding will produce certain compression distortion. Especially, when a larger Quantization Parameter (QP) is used for compressing the depth map, the compression distortion will be more serious. As a result, at the decoding end, the quality of the depth map reconstructed by decoding will be greatly reduced, which will lead to problems that obvious noises will be in the generated depth map of the target view, and an edge of the depth map does not completely match an actual texture edge. One of representations of the problems reflected on the texture map is that there is a transition zone at the junction of the foreground and the background, and the edge of the foreground is not steep enough, and there are obvious noises.

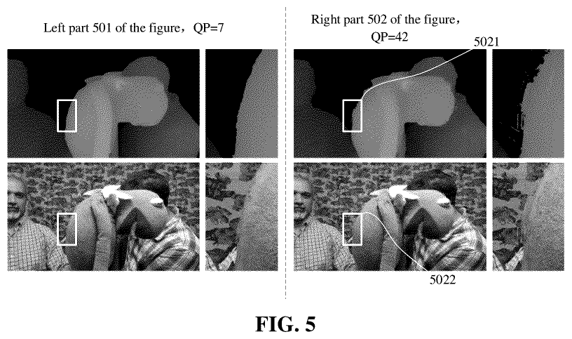

For example, as shown in FIG. 5, the left part 501 of the figure shows an effect of compressing the depth map by using the quantization parameter QP=7, and the right part 502 of the figure shows an effect of compressing the depth map by using the quantization parameter QP=42. As can be seen from FIG. 5, the map 5021 in the white rectangular frame in the right part 502 of the figure has more noises, which, reflected in the texture map, shows that there is a large transition zone at the junction of the foreground and the background in the picture region 5022.

Because of the compression distortion of the depth map, the qualities of the depth map and a texture map generated by a VWS will be reduced. Therefore, in order to generate high-quality depth map and texture map, it is necessary to compress the depth map by using as small QP as possible. This limits the compression degree of the depth map, thereby leading to an increase of encoding overhead of the depth map, a reduction of encoding efficiency, and a objective reduction of the overall efficiency of the compression encoding for “multi-view videos and multi-view depth maps”.

In view of this, embodiments of the present disclosure provide a method for generating a virtual view, and the method can be applied to any electronic device with data processing capability. The electronic device can be any device with video encoding and decoding function or only decoding function, such as a television, a projector, a mobile phone, a personal computer, a tablet computer, a Virtual Reality (VR) head-mounted device, etc. The functions realized by method for generating a virtual view can be implemented by calling program codes by a processor in the electronic device, of course, the program codes can be stored in a computer storage medium. As can be seen, the electronic device at least includes a processor and a storage medium.

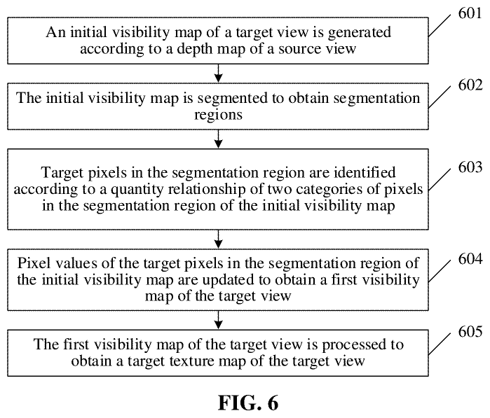

FIG. 6 is an implementation flowchart of a method for generating a virtual view according to an embodiment of the disclosure. As shown in FIG. 6, the method may include the following operations 601 to 605.

In operation 601, an initial visibility map of a target view is generated according to a depth map of a source view.

It can be understood that in a case where there are depth maps of more than one source view, the electronic device can generate the initial visibility map of the target view based on the depth maps of these source views. In some embodiments, the electronic device may obtain the initial visibility through the visibility generating module 202 shown in FIG. 2. It should be noted that the visibility map has an identical meaning to the depth map, and both of them indicate a distance relationship between a scene and a position of a camera. The visibility map is different from the depth map in that, in the visibility map, the closer to the position of the camera, the smaller the pixel value.

In operation 602, the initial visibility map is segmented to obtain segmentation regions.

In the embodiment of the present disclosure, the segmentation algorithm is not limited and the segmentation algorithm may be any algorithm capable of segmenting the initial visibility map into multiple segmentation regions. For example, the segmentation algorithm is a superpixel segmentation algorithm. The superpixel segmentation algorithm may include a variety of algorithms and is not limited in the embodiments of the present disclosure. For example, the superpixel segmentation algorithm can be a Simple Linear Iterative Cluster (SLIC) superpixel segmentation algorithm, a Superpixels Extracted via Energy-Driven Sampling (SEEDS) algorithm, a Contour-Relaxed Superpixels (CRS) algorithm, an Efficient Topology Preserving Segmentation (ETPS) algorithm or an Entropy Rate Superpixels Segmentation (ERS) algorithm, etc.

Compared with other superpixel segmentation algorithms, the SLIC superpixel segmentation algorithm is ideal in running speed, compactness of generated superpixels and contour preservation. Therefore, in some embodiments, the electronic device adopts the SLIC superpixel segmentation algorithm to perform superpixel segmentation on the initial visibility map, which can improve the quality of the target texture map to a certain extent without significantly increasing the processing time, so that the objective quality and subjective effect of the finally obtained target texture map and the corresponding obtained target viewport are obviously improved.

In operation 603, target pixels in the segmentation region are identified according to a quantity relationship of two categories of pixels in the segmentation region of the initial visibility map.

The electronic device classifies pixels in the segmentation region into two categories by using a classification algorithm, where one category is the target pixel, and the other category is the non-target pixel which does not need to be updated. The classification algorithm used is not limited in this disclosure. The classification algorithm may include a variety of algorithms. For example, the classification algorithm can be the K-means clustering algorithm, the decision tree, the Bayesian algorithm, an artificial neural network, a support vector machine or classification based on association rules.

In some embodiments, the electronic device may implement the operation 603 as follows. Pixel values of pixels in the segmentation region of the initial visibility map are clustered to at least obtain: a pixel number of a first category of pixels and a pixel number of a second category of pixels, and a pixel value of a cluster centroid of the first category of pixels and a pixel value of a cluster centroid of the second category of pixels; and the target pixels in the segmentation region are determined according to one of: a relationship between the pixel number of the first category of pixels and the pixel number of the second category of pixels, or a relationship between the pixel value of the cluster centroid of the first category of pixels and the pixel value of the cluster centroid of the second category of pixels.

It can be understood that, each segmentation region has a corresponding clustering result. The clustering algorithm may include a variety of algorithms and is not limited in the embodiments of the present disclosure. For example, the clustering algorithm may be the K-means clustering algorithm.

In some embodiments, the electronic device may determine, based on a clustering result, the target pixels in the segmentation region as follows. In a case where a first operation result of subtracting the pixel value of the cluster centroid of the second category of pixels from the pixel value of the cluster centroid of the first category of pixels is greater than or equal to a first threshold and a second operation result of dividing the pixel number of the first category of pixels by the pixel number of the second category of pixels is greater than or equal to a second threshold, the second category of pixels are determined as the target pixels in the segmentation region. Accordingly, in this case, the first category of pixels are the non-target pixels.

In a case where a third operation result of subtracting the pixel value of the cluster centroid of the first category of pixels from the pixel value of the cluster centroid of the second category of pixels is greater than or equal to the first threshold and a fourth operation result of dividing the pixel number of the second category of pixels by the pixel number of the first category of pixels is greater than or equal to the second threshold, the first category of pixels are determined as the target pixels in the segmentation region. Accordingly, in this case, the second category of pixels are the non-target pixels.

In a case where the first operation result is less than the first threshold or the second operation result is less than the second threshold, and the third operation result is less than the first threshold or the fourth operation result is less than the second threshold, both the first category of pixels and the second category of pixels are determined as the non-target pixels in the segmentation region.

Simply put, assuming that the pixel value of the cluster centroid of the first category of pixels is represented by cen₁, the pixel value of the cluster centroid of the second category of pixels is represented by cen₂, the pixel number of the first category of pixels is represented by num₁, and the pixel number of the second category of pixels is represented by num₂, then the target pixels and the non-target pixels can be determined as follows: a) if cen₁-cen₂≥first threshold and num₁/num₂ second threshold, then the first category of pixels are the non-target pixels and the second category of pixels are the target pixels; b) if cen₂-cen₁≥first threshold and num₁/num₂ second threshold, the first category of pixels are the target pixels and the second category of pixels are the non-target pixels, and c) in the cases other than the case a) and case b), both the first category of pixels and the second category of pixels are the non-target pixels, and the pixel values of the pixels in the corresponding segmentation region are not processed.

In operation 604, pixel values of the target pixels in the segmentation region of the initial visibility map are updated to obtain a first visibility map of the target view.

There may be a variety of ways to update the pixel values of the target pixels. For example, the electronic device may filter the pixel values of the target pixels in the initial visibility map to achieve the update of the pixel values. For another example, the electronic device can also replace the pixel values of the target pixels in the initial visibility map to achieve the update of the pixel values. Each segmentation region corresponds to one pixel replacement value. The pixel replacement value can be an average value of pixel values of non-target pixels in the corresponding segmentation region. In the case of using the clustering algorithm, each segmentation region corresponds to one cluster centroid of the category of the non-target pixels, so the pixel value of this cluster centroid can be used as the pixel replacement value.

In operation 605, the first visibility map of the target view is processed to obtain a target texture map of the target view.

The electronic device may process the first visibility map in a variety of ways. For example, in some embodiments, the electronic device may directly shade the first visibility map to obtain a target texture map of the target view. As another example, in some embodiments, the electronic device may also implement the processing of the first visibility map by operations 805 to 808 or by operations 905 to 909 in the following embodiments.

It can be understood that the transition zone is mainly distributed at the junction of the foreground and the background of the picture, and the noise regions are mainly scattered on the background. However, most of the segmentation algorithms segment the regions based on the texture content of the picture, especially for the case of the superpixel segmentation algorithm. If the texture map is segmented, the texture map is usually segmented along the junction of the foreground and the background. However, since the noises in the background region do not exist along the junction of the foreground and the background as is the case for the transition zone, but the noises are scattered in the background region, the noise region will not be taken into account when the region segmentation (especially in superpixel segmentation) is implemented. That is to say, the size of the noise region will not affect the size and shape of the segmentation region. In a general superpixel segmentation algorithm, the sizes of segmentation regions are relatively uniform. Especially in the SLIC algorithm, all segmentation regions are uniform in size, and the number of pixels in each segmentation region is basically the same as or similar to that in other segmentation regions. The segmentation is performed along the junction of the foreground and the background, and the transition zone always exists along the junction, thus when region segmentation is performed, if the segmentation region is a large region, the number of pixels pruned down from the transition zone will be more, and if the segmentation region is a small region, the number of pixels pruned down from the transition zone will be less. That is to say, the number of pixels in the transition zone in the segmentation region varies with the size of the segmentation region. However, the number of pixels in the noise region in the segmentation region is almost constant, and the number of pixels in the noise region in the segmentation region does not change with the size of the segmentation region. The reasons are as follows.

The noise regions are usually scattered in the background region of the picture, most parts of the background region are relatively smooth, and detail information contained in the background region is less, so the sizes of the segmentation regions are relatively uniform, the sizes of the noise regions will not affect the segmentation result, and the shapes and sizes of the segmentation regions will hardly be affected by the noises regions. If the segmentation result of the texture map is directly applied to the depth map, i.e., the segmentation region of the texture map is regarded as a respective one of segmentation regions of the depth map, and the noises (i.e., the target pixels) in the segmentation region are identified based on the segmentation result, the problem that the large noise regions are difficult to be identified will appear. The reasons for the problem are as follows.

Since the detail information of the texture map is rich to cause the sizes of the segmentation regions are small, i.e., the segmentation result of the texture map is usually a dense segmentation network. Although most of the noises occupy a very small proportion in each segmentation region, there are still large noise regions in the segmentation region, which may occupy most area of the segmentation region or even occupy the whole segmentation region. Thus, if the segmentation network is directly tiled on the depth map, when the noise pixels (i.e. target pixels) are identified based on the quantity relationship of the two categories of pixels in the segmentation region, a problem thus caused is that noise pixels in these segmentation regions having large noise regions are difficult to be identified. The initial visibility map is also a depth map in essence, and compared with the texture map, the depth map presents less picture details. Therefore, applying the segmentation result of the texture map to the depth map is unfavorable for identifying the large noise regions of the depth map. In practical applications of the method of de-noising and edge enhancement of the depth map based on the segmentation result of the texture map, considering the many details and high complexity of the texture map, if the better segmentation effect and better edge sharpening of the final target texture map are required, the number of segmentation regions cannot be set too small, which will cause that the identification ability for the noise regions is reduced, and the large noise regions cannot be well identified, thus affecting the optimization effect of this technology. In view of this, in the embodiments of the present disclosure, the initial visibility map (essentially equivalent to the depth map) is directly segmented, so that the number of segmentation regions of the depth map is not limited by the segmentation result of the texture map. That is to say, the sizes of the segmentation regions of the depth map can be arbitrarily set without being limited by the small segmentation regions of the texture map. In this way, the large noise regions of the initial visibility map can be accurately identified according to the quantity relationship of the two categories of pixels in each of the obtained segmentation region, so that the small noise regions and the large noise regions of the final target texture map are both obviously reduced. It can be understood that, if the quality of the target texture map can be ensured at the decoding end, it is possible to provide favorable conditions for the encoding end to use larger quantization parameters to perform the compression encoding on the depth map. Furthermore, using the larger quantization parameters can reduce the encoding overhead of the depth map, thus improving the overall encoding efficiency.

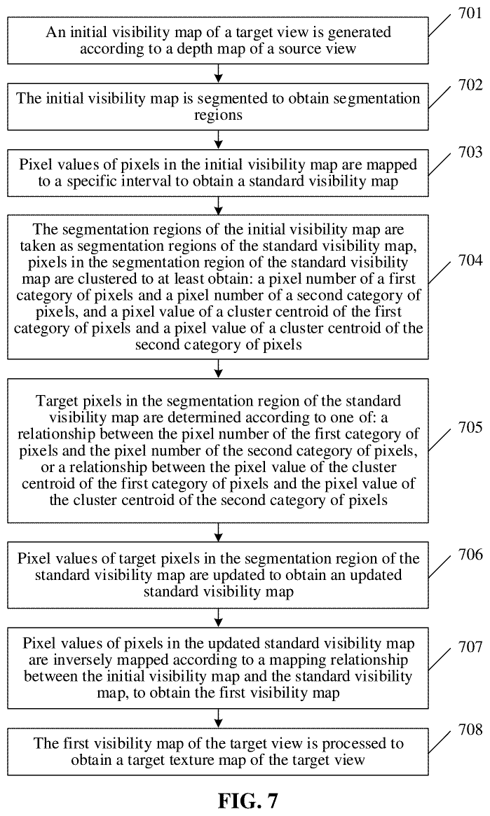

Embodiments of the present disclosure further provide a method for generating a virtual view. FIG. 7 is an implementation flowchart of a method for generating a virtual view according to an embodiment of the disclosure. As shown in FIG. 7, the method may include the following operations 701 to 708.

In operation 701, an initial visibility map of a target view is generated according to a depth map of a source view.

In some embodiments, the electronic device may decode the input bitstream to obtain an atlas of the depth map of the source view; then the electronic device performs pruned view reconstruction on the atlas of the depth map of the source view to obtain the depth map of the source view.

In the embodiment of the present disclosure, the number of source views according to which the initial visibility map is generated is not limited herein. The electronic device may generate the initial visibility map of the target view according to the depth maps of one or more source views.

In operation 702, the initial visibility map is segmented to obtain segmentation regions.

In operation 703, pixel values of pixels in the initial visibility map are mapped to a specific interval to obtain a standard visibility map.

The specific interval is not limited herein. For example, the specific interval can be [0,255]. Of course, in practical applications, engineers can also configure other specific intervals according to actual requirements.

In operation 704, the segmentation regions of the initial visibility map are taken as segmentation regions of the standard visibility map, pixels in the segmentation region of the standard visibility map are clustered to at least obtain: a pixel number of a first category of pixels and a pixel number of a second category of pixels, and a pixel value of a cluster centroid of the first category of pixels and a pixel value of a cluster centroid of the second category of pixels.

It can be understood that the initial visibility map can be segmented into several segmentation regions by operation 702. The electronic device can classify pixels in a part of or all of the segmentation regions of the initial visibility map, respectively. For example, in some embodiments, the electronic device may use a classification algorithm (e.g. K-means clustering algorithm) to divide the pixels in each segmentation region of the initial visibility into two categories: non-target pixels belonging to the background region, and target pixels belonging to the noise region and the transition zone.

In operation 705, target pixels in the segmentation region of the standard visibility map are determined according to one of: a relationship between the pixel number of the first category of pixels and the pixel number of the second category of pixels, or a relationship between the pixel value of the cluster centroid of the first category of pixels and the pixel value of the cluster centroid of the second category of pixels.

In some embodiments, the electronic device may implement the operation 705 as follows. In a case where a first operation result of subtracting the pixel value of the cluster centroid of the second category of pixels from the pixel value of the cluster centroid of the first category of pixels is greater than or equal to a first threshold and a second operation result of dividing the pixel number of the first category of pixels by the pixel number of the second category of pixels is greater than or equal to a second threshold, the second category of pixels are determined as the target pixels in the segmentation region; in a case where a third operation result of subtracting the pixel value of the cluster centroid of the first category of pixels from the pixel value of the cluster centroid of the second category of pixels is greater than or equal to the first threshold and a fourth operation result of dividing the pixel number of the second category of pixels by the pixel number of the first category of pixels is greater than or equal to the second threshold, the first category of pixels are determined as the target pixels in the segmentation region; and in a case where the first operation result is less than the first threshold or the second operation result is less than the second threshold, and the third operation result is less than the first threshold or the fourth operation result is less than the second threshold, it is determined that both the first category of pixels and the second category of pixels are the non-target pixels in the segmentation region. In some embodiments, the first threshold is within a range of [25,33] and the second threshold is within a range of [5,10]. For example, the first threshold is 30 and the second threshold is 6.

In operation 706, pixel values of target pixels in the segmentation region of the standard visibility map are updated to obtain an updated standard visibility map.

In some embodiments, the pixels in the segmentation region of the standard visibility map are clustered to further determine non-target pixels in the segmentation region. Accordingly, the electronic device may implement the operation 706 as follows. A pixel replacement value of the segmentation region is determined according to pixel values of the non-target pixels in the segmentation region of the standard visibility map; and the pixel values of the target pixels in the segmentation region of the standard visibility map are updated to the pixel replacement value of the segmentation region, to obtain the updated standard visibility map.

In some embodiments, the electronic device may determine a pixel value of a cluster centroid of the non-target pixels in the segmentation region of the standard visibility map as the pixel replacement value of the segmentation region.

In other embodiments, the electronic device may also determine an average of the pixel values of the non-target pixels in the segmentation region of the standard visibility map as the pixel replacement value of the segmentation region.

In related art, filtering is often used to improve the quality of the noises and the transition zone in the visibility map, so that the influence of the noises and the transition zone is expected to be dispersed. However, as a result, correct pixel values of the pixels (i.e., the non-target pixels) around the noises and the transition zone will be changed, which makes the objective quality and subjective effect of the final target viewport slightly worse.

In the embodiment of the present disclosure, the pixel values in these noise regions and transition zones (i.e., target pixels) are replaced with an approximate correct value (i.e. pixel replacement value), so that the pixel values of non-target pixels around the target pixels are not changed. Compared with the filtering method, the method provided in the present disclosure can make the target pixels whose pixel values are replaced fuse with pixels in the surrounding regions more naturally, so that the objective quality and subjective effect of the final target viewport are better.

In operation 707, pixel values of pixels in the updated standard visibility map are inversely mapped according to a mapping relationship between the initial visibility map and the standard visibility map, to obtain the first visibility map.

It can be understood that, the quality of the initial visibility map can be improved by operations 703 to 707. That is to say, before the target pixels in the initial visibility map are determined, the pixel values of the pixels in the map are mapped to a specific interval, and then the pixel values of the pixels in the mapping result (i.e., the standard visibility map) are classified, and the pixel values of the target pixels determined by classification are updated; finally, the updated standard visibility map is inversely mapped into the first visibility map. In this way, the method for generating a virtual view has certain generalization ability, and can adapt to the picture processing under various scenes. According to the method for generating a virtual view, the large noise regions and the small noise regions of the pictures under various scenes can be effectively reduced.

In operation 708, the first visibility map of the target view is processed to obtain a target texture map of the target view.

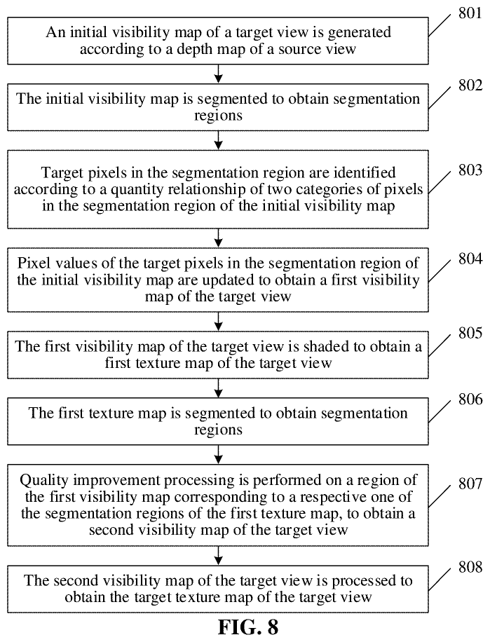

Embodiments of the present disclosure further provide a method for generating a virtual view. FIG. 8 is an implementation flowchart of a method for generating a virtual view according to an embodiment of the disclosure. As shown in FIG. 8, the method may include the following operations 801 to 808.

In operation 801, an initial visibility map of a target view is generated according to a depth map of a source view.

In operation 802, the initial visibility map is segmented to obtain segmentation regions.

In some embodiments, the electronic device may segment, according to a preset first number of segmentation regions, the initial visibility map to obtain the segmentation regions. In the embodiment of the present disclosure, the first number is not limited, and the first number may be an arbitrary value. For example, the first number is 1000, that is to say, the initial visibility map is segmented into 1000 segmentation regions.

In operation 803, target pixels the segmentation region are identified according to a quantity relationship of two categories of pixels in the segmentation region of the initial visibility map.

In operation 804, pixel values of the target pixels in the segmentation region of the initial visibility map are updated to obtain a first visibility map of the target view.

In operation 805, the first visibility map of the target view is shaded to obtain a first texture map of the target view.

In operation 806, the first texture map is segmented to obtain segmentation regions.

In some embodiments, the electronic device may segment, according to a preset second number of segmentation regions, the first texture map to obtain the segmentation regions.

In the embodiment of the present disclosure, the second number is not limited and the second number may be an arbitrary value. For example, the second number is 3000, that is to say, the first texture map is segmented into 3000 segmentation regions.

In some embodiments, the second number is greater than the first number. In this way, the initial visibility map is segmented based on the first number, which can improve the ability of identifying the noise pixels (i.e. target pixels) in the segmentation region; and the first texture map is segmented based on the second number, which can improve the ability of identifying pixels (i.e., target pixels) in the transition zone in the segmentation region.

In operation 807, quality improvement processing is performed on a region of the first visibility map corresponding to a respective one of the segmentation regions of the first texture map, to obtain a second visibility map of the target view.

It can be understood that by performing quality improvement processing on the initial visibility map through operations 802 to 804, the large noise regions and the small noise regions of the initial visibility map can be effectively removed. On this basis, the quality improvement processing is performed on the obtained first visibility map based on the segmentation result of the first texture map, so that the transition zones of the initial visibility map can be further reduced, and the large noise regions of the finally obtained target texture map are obviously reduced, while the edge is more sharpened. If the quality of the target texture map can be ensured at the decoding end, it is possible to provide favorable conditions for the encoding end to use larger quantization parameters to perform the compression encoding on the depth map. Furthermore, using the larger quantization parameters can reduce the encoding overhead of the depth map, thus improving the overall encoding efficiency.

It can be understood that the primary purpose of the quality improvement processing is to reduce the transition zones of the first visibility map, and of course, if there are noises in the first visibility map, the noises will be eliminated in the processing. In some embodiments, the electronic device may perform de-noising and edge enhancement processing on the first visibility map to implement the quality improvement of the first visibility map, thereby obtaining a second visibility map of the target view.

It can be understood that the transition zone is a transition zone at the junction of the foreground and the background in the picture, and the existence of the transition zone leads to deviation in the subsequent analysis and understanding of the map, i.e., the transition at the junction in the final target viewport is unnatural.

The electronic device may perform edge enhancement processing on the first visibility map in a variety of ways. For example, the electronic device filters the first visibility map. For another example, the electronic device performs replacement processing on pixel values at the noise regions and the transition zones of the first visibility map. That is to say, the electronic device classifies pixels of a region of the first visibility map corresponding to a respective one of the segmentation regions of the first texture map, determines the target pixels in the region according to a quantity relationship of two categories of pixels in the classification result, and finally replaces the pixel values of the target pixels with the pixel replacement value.

In some embodiments, the method for determining the target pixels in each segmentation region of the initial visibility map mentioned in the preceding embodiments is also applicable to determining the target pixels in each segmentation region of the first visibility map; and the method for updating the target pixels in the initial visibility map is also applicable to updating the target pixels in the first visibility map, which are not repeated herein.

In operation 808, the second visibility map of the target view is processed to obtain the target texture map of the target view.

The electronic device can process the second visibility map in a variety of ways. For example, in some embodiments, the electronic device directly shades the second visibility map to obtain a target texture map of the target view. As another example, in other embodiments, the electronic device may implement the operation 808 by operations 905 to 909 in the following embodiments, except that the object of the iterative processing is the second visibility map when operations 905 to 909 are performed.

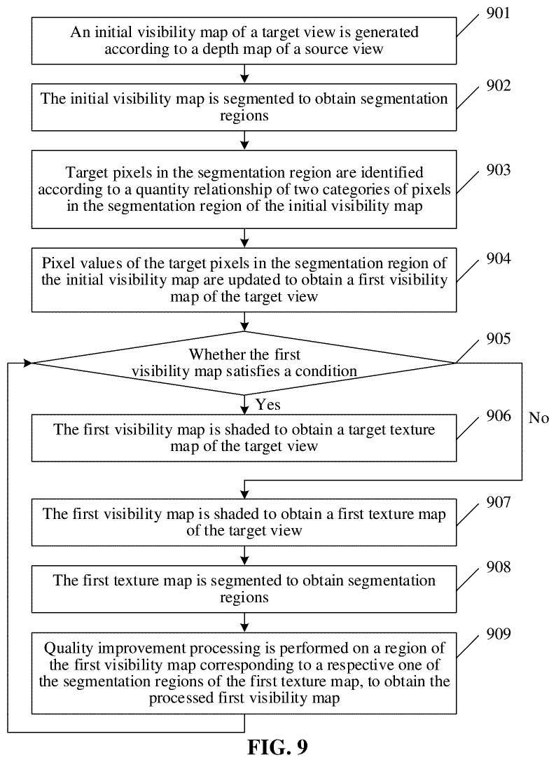

Embodiments of the present disclosure further provide a method for generating a virtual view. FIG. 9 an implementation flowchart of a method for generating a virtual view according to an embodiment of the disclosure. As shown in FIG. 9, the method may include operations 901 to 909.

In operation 901, an initial visibility map of a target view is generated according to a depth map of a source view.

In operation 902, the initial visibility map is segmented to obtain segmentation regions.

In some embodiments, the initial visibility map is segmented, according to a preset first number of segmentation regions, to obtain the segmentation regions.

In operation 903, target pixels in the segmentation region are identified according to a quantity relationship of two categories of pixels in the segmentation region of the initial visibility map.

In operation 904, pixel values of the target pixels in the segmentation region of the initial visibility map are updated to obtain a first visibility map of the target view.

In operation 905, it is determined whether the first visibility map satisfies a condition, if so, operation 906 is performed; otherwise, the operation 907 is performed.

It can be understood that, in a case where the first visibility map does not satisfy the condition, iterative optimization processing is repeatedly performed on the first visibility map until a processed first visibility map satisfies the condition, and a first visibility map satisfying the condition is shaded to obtain the target texture map of the target view. In this way, the quality of the first visibility map can be further improved, thereby improving the quality of the target texture map. The iterative optimization processing includes the operations 907 to 909.

The condition may be one of a variety of conditions. For example, the condition is that N comparison results are all within a preset range, where the comparison result is a difference (such as difference between the pixel values) between a first visibility map obtained at present and a visibility map obtained in a previous time (which may be first visibility map obtained in a previous time or the initial visibility map), and N is an integer greater than 0. For another example, the number of iterations reaches a preset number. For another example, the condition is that a noise region and/or a transition zone of the first visibility map has an area smaller than a preset threshold. In some embodiments, target pixels in the first visibility map may be identified, and areas of the noise region and the transition zone in the visibility map may be determined based on the number of target pixels. It can be understood that if the first visibility map obtained at present satisfies the condition the cyclic, it is indicated that the iteration tends to converge, and operation 906 is performed at this time in order to conserve computational resources and the like.

In operation 906, the first visibility map is shaded to obtain a target texture map of the target view.

This operation can be implemented by the shading module 203 shown in FIG. 2. According to the texture map of the source view, the target visibility map of the target view is shaded to obtain the target texture map of the target view.

In operation 907, the first visibility map is shaded to obtain a first texture map of the target view.

This operation can be implemented by the shading module 203 shown in FIG. 2. According to the texture map of the source view, the target visibility map of the target view is shaded to obtain the target texture map of the target view.

In operation 908, the first texture map is segmented to obtain segmentation regions.

In some embodiments, according to a preset second number of segmentation regions, the initial visibility map is segmented to obtain the segmentation regions, where the first number is less than the second number.

In operation 909, quality improvement processing is performed on a region of the first visibility map corresponding to a respective one of the segmentation regions of the first texture map, to obtain the processed first visibility map, and then the operation 905 is returned to be performed.

It can be understood that the scene content expressed at a position in the visibility map is basically consistent with the same position in the texture map. Therefore, the electronic device can directly copy the segmentation result of the texture map to the visibility map, and take the segmentation regions of the texture map as the segmentation regions of the visibility map. Compared with the segmentation performed on the visibility map, the segmentation performed on the texture map can produce a better segmentation at the edge (i.e., the junction), so that the more accurate segmentation result of the texture map can better guide the quality improvement processing performed by the electronic device, and it will be very beneficial to sharpen the edge, so that the noises and transition regions at the edge of the target texture map obtained after the quality improvement and shading are obviously reduced.

In the embodiment of the present disclosure, after the first visibility map is obtained through operations 901 to 904, instead of directly taking the shading result (i.e., the first texture map) of the first visibility map as the final target texture map of the target view, the first visibility map is optimized in a cyclic iterative manner. In this way, the edge of the finally optimized visibility map can be more sharpened, so that the quality of the target texture map of the target view generated based on this method in the embodiment of the present disclosure is better.

It can be understood that, if the quality of the target texture map can be ensured at the decoding end, it is possible to provide favorable conditions for the encoding end to use larger quantization parameters to perform the compression encoding on the depth map. Furthermore, using the larger quantization parameters can reduce the encoding overhead of the depth map, thus improving the overall encoding efficiency.

Embodiments of the disclosure provide a rendering method. The rendering method can be applied not only to electronic device, but also to rendering device, and the rendering method can include performing pruned view reconstruction on an atlas of a depth map of a source view to obtain the depth map of the source view; performing operations in the method for generating a virtual view on the depth map of the source view to obtain a target texture map of a target view; and generating a target viewport of the target view according to the target texture map of the target view.

The description of embodiments of the rendering method is similar to the description of the embodiments of the other methods described above, and the embodiments of the rendering method have similar beneficial effects as the embodiments of the other methods described above. Technical details not disclosed in the embodiments of the rendering method are understood with reference to the above description of the embodiments of the other methods.

Embodiments of the disclosure provide a decoding method. The decoding method includes decoding input bitstream to obtain an atlas of a depth map of a source view; performing pruned view reconstruction on the atlas of the depth map of the source view to obtain the depth map of the source view; performing operations in the method for generating a virtual view on the depth map of the source view to obtain a target texture map of a target view; and generating a target viewport of the target view according to the target texture map of the target view.

The description of embodiments of the decoding method is similar to the description of the embodiments of the other methods described above, and the embodiments of the decoding method have similar beneficial effects as the embodiments of the other methods described above. Technical details not disclosed in the embodiments of the decoding method are understood with reference to the above description of the embodiments of the other methods.

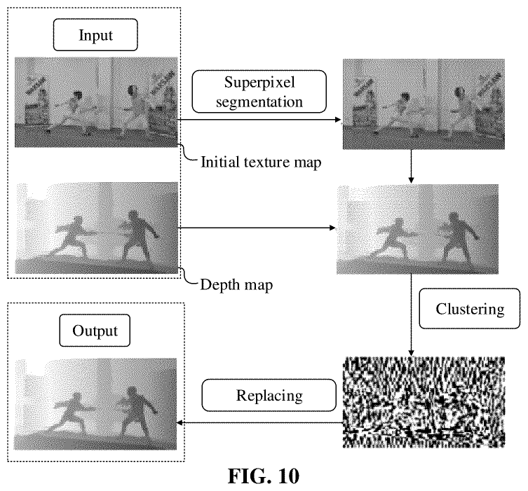

In related art, the depth map (that is, the initial visibility map of the target view) during the view generation is optimized by performing the superpixel segmentation on the texture map, so as to obtain the target texture map. Due to the inaccurate depth estimation and the compression distortion, the generated depth map of the target view will have some noise regions and transition zones. The technical flowchart of optimizing the depth map during the view generation by performing the superpixel segmentation on the initial texture map of the target view is shown in FIG. 10. In the technology, firstly, the superpixel segmentation is performed on the initial texture map of the target view, and then the result of the superpixel segmentation obtained from the initial texture map are applied to the depth map of the target view to obtain several superpixels in the depth map. For each superpixel, the noise regions and transition zones are extracted by clustering, and then these regions are replaced by an appropriate value. Then, the noise regions and transition zones of the final depth map will be greatly reduced in number.

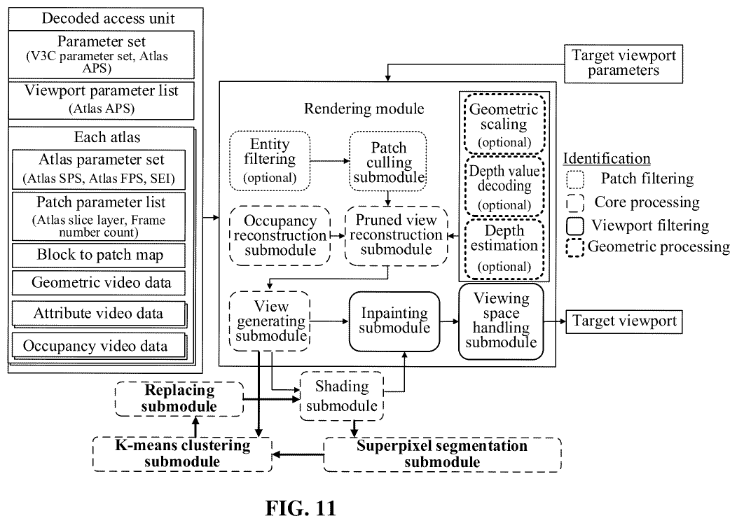

The technology of optimizing the depth map during the view generation by performing the superpixel segmentation on the texture map is implemented based on the VWS of the MPEG 3DoF+TMIV6. In the VWS, the depth map exists in a form of the visibility map. The visibility map has an identical meaning to the depth map, and both of them indicate a distance relationship between a scene and a position of a camera. The visibility map is different from the depth map in that, in the visibility map, the closer to the position of the camera, the smaller the pixel value. After the technology of technology of optimizing the depth map during the view generation by performing the superpixel segmentation on the texture map is implemented on VWS, three new modules are introduced: a superpixel segmentation module, a K-means clustering module and a replacing module, as shown in FIG. 11. The superpixel segmentation module segments the texture map generated by the VWS by adopting superpixel segmentation algorithm, and applies the segmentation result to the generated visibility map to obtain several superpixels in the visibility map. The K-means clustering module performs clustering on each obtained superpixel of the visibility map by using the k-means clustering algorithm, so that the noise regions and transition zones that need to be processed can be separated from the regions that do not need to be processed, and finally the replacing module replaces pixel values of these regions that need to be processed.

The sizes of the transition zones of each superpixel can self-adapt to the number of the Superpixels (numSuperpixel) to a certain extent, so it can ensure that the proportion of the transition zones in each superpixel will not be too high. That is to say, the threshold determination condition for the transition zones can be satisfied and the transition zones can be identified. However, the noise regions are generally scattered in the map, and the sizes of the noise regions of each superpixel generally do not change with the change of the numSuperpixel. When the adopted numSuperpixel is large, the number of pixels in each superpixel is small. The proportion of noise regions in superpixel will be too large, which is not conducive to the identification of noise regions.

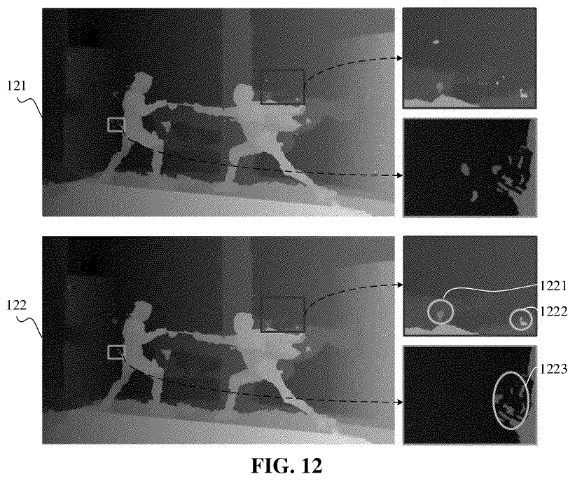

In practical applications of the technique where the depth map during the view generation is optimized by performing the superpixel segmentation on the texture map, considering the details and high complexity of texture map, if the better segmentation effect is required, the numSuperpixel cannot be set too small, which will cause that the identification ability for the noise regions is reduced, and the large noise regions cannot be well identified, thus affecting the optimization effect of this technology. As shown in FIG. 12, the depth map 121 is a map before optimization, i.e., the initial visibility map of the target view generated by the VWS. The depth map 122 is a depth map obtained by optimizing the depth map 121 during the view generation by performing the superpixel segmentation on the texture map, where numSuperpixel is 3000. It can be seen that, compared with the depth map 121, the depth map 122 has a part of small noise regions removed, but the processing effect for some large noise regions (such as regions in circles 1221, 1222 and 1223 in the map) is poor, and the noise regions in these circles still exist. In view of this, an exemplary application of the embodiment of the present disclosure in a practical application scenario will be described below.

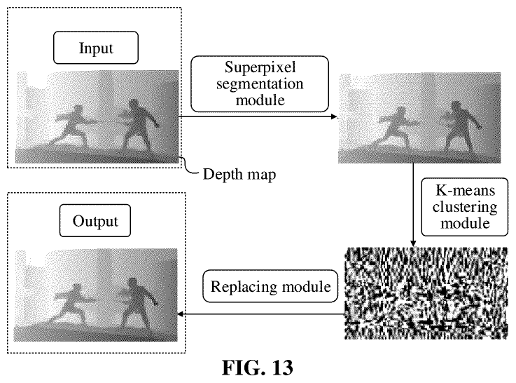

In the embodiment of the present disclosure, there is provided a technology for optimizing a depth map during the view generation by using superpixel segmentation on the depth map. As shown in FIG. 13, superpixel segmentation is performed on the inputted depth map to obtain multiple superpixels on the depth map. For each superpixel, the noise regions in the superpixel are separated by clustering. Finally, the pixel values of the pixels in the separated noise regions are replaced.

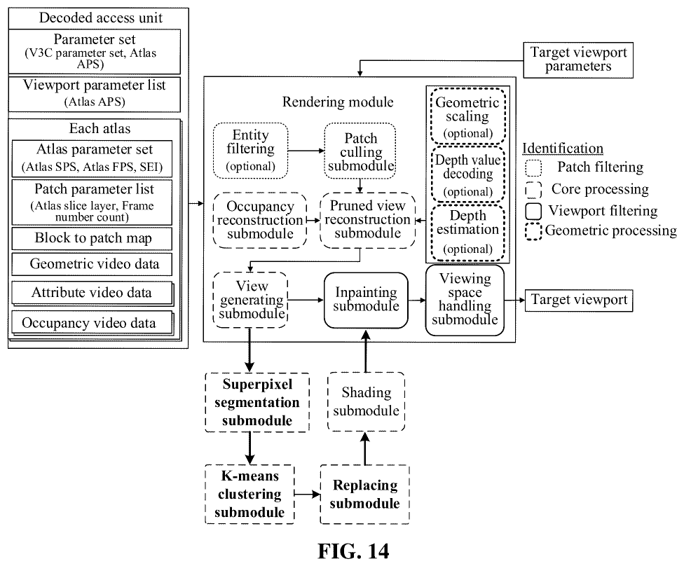

The method for generating a virtual view (i.e., the method for optimizing the depth map) provided by the embodiment of the disclosure is implemented on the basis of a VWS, the method can remove the large noise regions on the visibility map under the target view obtained by the VWS visibility map generating module, thereby improving the quality of the generated texture map under the target view. The technical scheme involves three modules: a superpixel segmentation module, a K-means clustering module and a replacing module. The system architecture after introducing the technical scheme is shown in FIG. 14.

Firstly, a visibility map D under a target view (i.e., an initial visibility map of the target view) is obtained from an operation of generating a visibility map by the VWS. Because of the test sequences for different scene contents, pixel values in the visibility map have different ranges. In some embodiments, the pixel values of the visibility map D are transformed into an interval of 0-255 by using a linear mapping to obtain a visibility map D2 (i.e., the standard visibility map). The visibility map D2 is segmented by using the superpixel segmentation algorithm to obtain several superpixels Si divided from the visibility map D2. For each superpixel Si, k-means clustering algorithm is used to divide the pixels in the superpixel Si into two categories: C1 and C2. The cluster centroids of C1 and C2 are denoted as cen1 and cen2, respectively, and the number of pixels included in C1 and C2 are num1 and num2, respectively. The pixel value of the cluster centroid cen1 is compared with the pixel value of the cluster centroid cen2, and the number of pixels of C1 num1 is compared with the number of pixels of C2 num2, and then the visibility map D2 is processed by the following procedure including a) to c). In a), if cen1-cen2≥threshold 1 (i.e., the first threshold) and num1/num2 threshold 2 (i.e., the second threshold), then C1 is considered as the background region and C2 is considered as the noise region (i.e., where the target pixels are located). In this case, all the pixels in C1 are not processed and the original values of the pixels in C1 are kept unchanged, and the values of all the pixels in C2 are replaced by the pixel value of cent. b) If cen2-cen1≥threshold 1 and num2/num1 threshold 2, then C2 is considered as the background region and C1 is the noise region. In this case, all the pixels in C2 are not processed and the original values of the pixels in C2 are kept unchanged, and the values of all the pixels in C 1 are replaced by the pixel value of cen₂. c) In the cases other the case a) and case b), all the pixels in C1 and C2 are not processed and the original values of the pixels in C1 and C2 are kept unchanged.

After the above processing, the optimized visibility map D3 (i.e., the updated standard visibility map) is obtained. The pixel values of pixels in visibility map D3 are inversely linearly mapped, and scaled to the original value range to obtain the visibility map D4 (i.e., the first visibility map). The shading operation is performed by using the visibility map D4 to obtain an optimized texture map T (i.e., the target texture map).

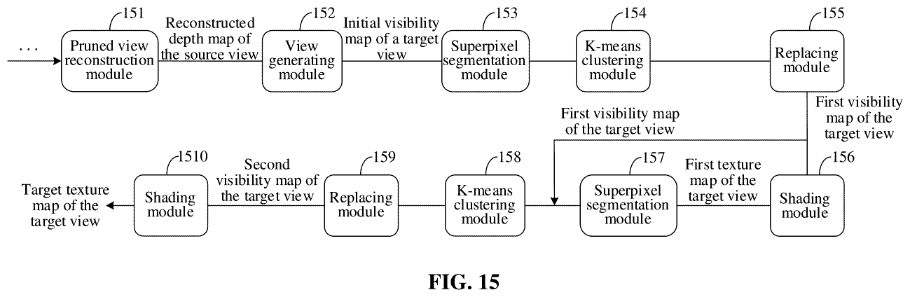

In some embodiments, the method for optimizing a depth map during the view generation by using the superpixel segmentation on the depth map provided by the embodiments of the present disclosure can also be combined with the method for optimizing a depth map during the view generation by using the superpixel segmentation on the texture map, so as to realize effects of both removing noises and sharpening edges of the visibility map under the target view obtained in the VWS visibility map generating module. The system architecture after the combination of the two technical schemes is shown in FIG. 15, operations 154 to 156 are included in the method for optimizing a depth map by using the superpixel segmentation on the depth map, and operations 158 to 1510 are included in the method for optimizing a depth map by using the superpixel segmentation on the texture map, and other modules before the pruned view reconstruction module 151 are not shown herein. As shown in FIG. 15, the depth map of the source view is obtained by the pruned view reconstruction module 151; the depth map of the source view is processed by a view synthesis module 152 to obtain an initial visibility map of a target view; the superpixel segmentation is performed on the initial visibility map by a superpixel segmentation module 152 to obtain multiple superpixels in the initial visibility map; the pixels in each of the superpixels in the initial visibility map are clustered by a k-means clustering module 154, thereby identifying target pixels (which may be pixels in the noise region or pixels in the transition zone) in each superpixel, the pixel values of the target pixels in each superpixel of the initial visibility map are replaced by a pixel replacement value by a replacing module 155, thereby obtaining a first visibility map; the first visibility map is shaded by the shading module 156 to obtain a first texture map; the first texture map is segmented by a superpixel segmentation module 157, the segmentation result is moved to the first visibility map, and the pixels in each the superpixel of the first visibility map are clustered by a k-means clustering module 158, so as to identify the target pixels in each superpixel of the first visibility map; the pixel values of the target pixels in each superpixel of the initial visibility map are replaced by the pixel replacement value by the replacing module 159, to obtain a second visibility map, and finally, the second visibility map is shaded by the shading module 1510 to obtain the target texture map.

The technical scheme provided by the embodiments of the disclosure is implemented on TMIV6, and is tested by the test sequences of the natural scene content in the Common Test Condition. The experimental parameters set for these test sequences are: the superpixel segmentation algorithm is the SLIC algorithm, the numSuperpixel is 1000, the threshold1 is 30, and the threshold2 is 6. The experimental result shows that the number of the noise regions of the generated depth map of the target view is greatly reduced after the technical scheme provided by the embodiments of the disclosure is introduced into VWS. Compared with the technology of optimizing the depth map during the view generation by using the superpixel segmentation on the texture map, the technical scheme provided by the embodiments of the disclosure still has good processing effect on the large noise regions. Without significantly increasing the rendering time, the technical scheme provided by the embodiments of the present disclosure improves the qualities of the depth map and the texture map of the target view to a certain extent.

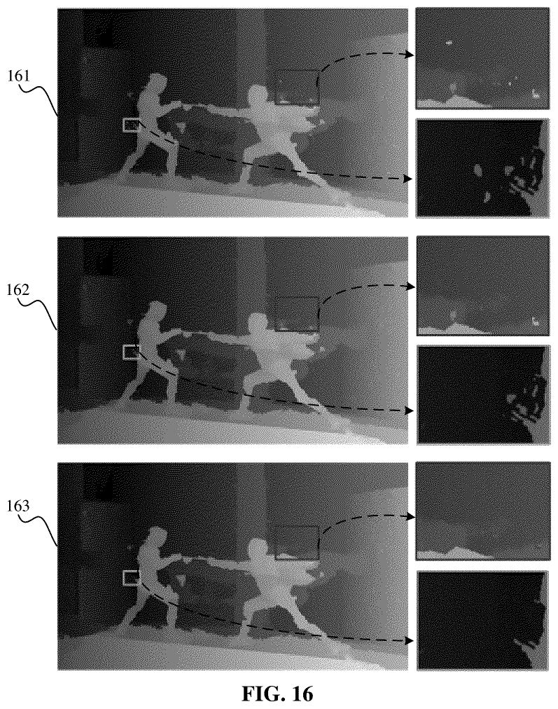

For example, FIG. 16 is an effect comparison diagram of the depth maps under test sequences in a fencing scene. As shown in FIG. 16, the depth map 161 is an initial visibility map generated by a VWS, and the depth map 161 is not optimized. The depth map 162 is a result diagram of optimizing the depth map 161 by using the superpixel segmentation performed on the texture map of the depth map 161 (hereinafter referred to as scheme 1), and the depth map 163 is a result diagram of optimizing the depth map 161 by using superpixel segmentation performed on the depth map 161 (hereinafter referred to as scheme 2). It can be seen that the number of the large noise regions of the depth map 163 is significantly reduced compared with the depth map 161 and depth map 162.

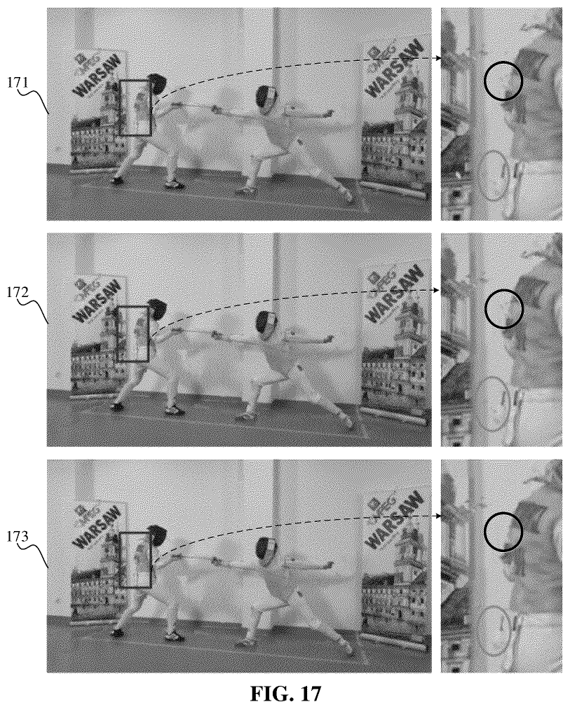

For another example, FIG. 17 is an effect comparison diagram of texture maps of test sequences in a fencing scene. As shown in FIG. 17, the texture map 171 is an initial texture map generated by a VWS, and the texture map 171 is not optimized. The texture map 172 is a result schematic diagram obtained by adopting the scheme 1. The texture map 173 is a result schematic diagram obtained by adopting the scheme 2. It can be seen that the number of the large noise regions of the obtained texture map 173 is obviously reduced compared with the texture map 171 and depth map 172.

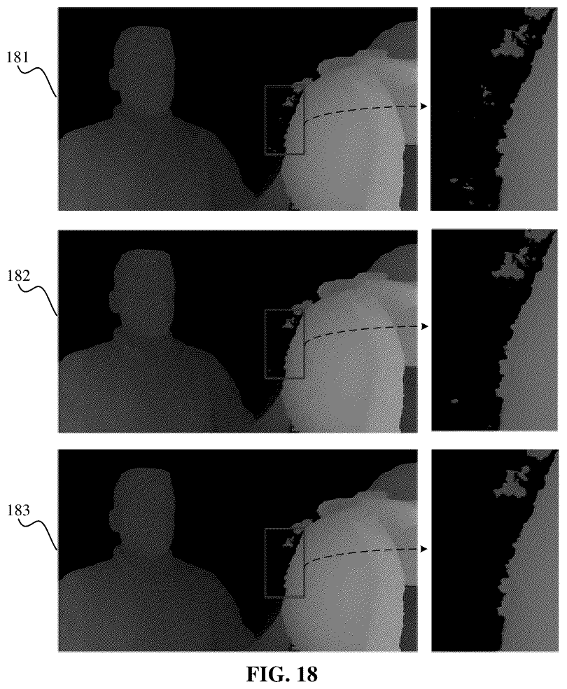

For another example, FIG. 18 is an effect comparison diagram of depth maps under test sequences in a frog scene. As shown in FIG. 18, the depth map 181 is an initial visibility map generated by a VWS, and the depth map 181 is not optimized. The depth map 182 is a result schematic diagram obtained by adopting the scheme 1. The depth map 183 is a result schematic diagram obtained by adopting the scheme 2. It can be seen that the number of the large noise regions of the obtained depth map 183 is obviously reduced compared with the depth map 181 and depth map 182.

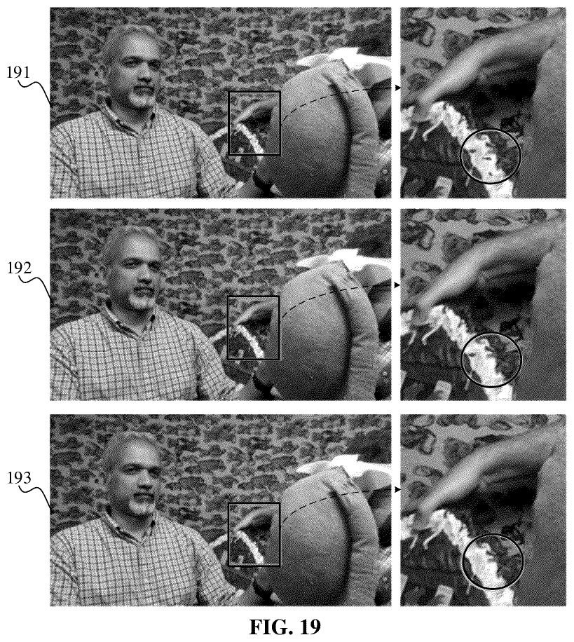

For another example, FIG. 19 is an effect comparison map of texture maps under test sequences in a frog scene. As shown in FIG. 19, the texture map 191 is an initial texture map generated by a VWS, and the texture map 191 is not optimized. The texture map 192 is a result schematic diagram obtained by adopting the scheme 1. The texture map 193 is a result schematic diagram obtained by adopting the scheme 2. It can be seen that the number of the large noise regions of the obtained texture map 193 is obviously reduced compared with the texture map 191 and texture map 192.

In the embodiments of the present disclosure, the noise regions of the depth map are separated by directly adopting the superpixel segmentation algorithm and the k-mean clustering algorithm on the depth map, thereby effectively avoiding the situation that the noise regions are not identified due to the large number of superpixels set during the superpixel segmentation on the texture map, thereby improving the quality of the depth map and the subjective effect of the texture map during the view generation.

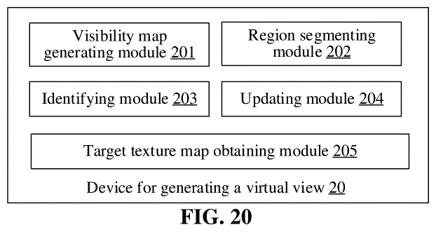

Based on the aforementioned embodiments, a device for generating a virtual view is provided by the embodiments of the present disclosure. FIG. 20 is schematic structural diagram of a device for generating a virtual view according to an embodiment of the present disclosure. As shown in FIG. 20, the device 20 includes: a visibility map generating module 201 configured to generate an initial visibility map of a target view according to a depth map of a source view; a region segmenting module 202, configured to segment the initial visibility map to obtain segmentation regions; an identifying module 203, configured to identify target pixels in the segmentation region according to a quantity relationship of two categories of pixels in the segmentation region of the initial visibility map; an updating module 204, configured to update pixel values of the target pixels in the segmentation region of the initial visibility map to obtain a first visibility map of the target view; and a target texture map obtaining module 205, configured to process the first visibility map of the target view to obtain a target texture map of the target view.

In some embodiments, the target texture map obtaining module 205 includes a shading unit configured to shade the first visibility map of the target view to obtain the target texture map of the target view.

In some embodiments, the target texture map obtaining module 205 is configured to shade the first visibility map of the target view to obtain a first texture map of the target view. The region segmenting module 202 is configured to segment the first texture map to obtain segmentation regions. The target texture map obtaining module 205 is configured to perform quality improvement processing on a region of the first visibility map corresponding to a respective one of the segmentation regions of the first texture map, to obtain a second visibility map of the target view, and process the second visibility map of the target view to obtain the target texture map of the target view.

In some embodiments, the target texture map obtaining module 205 is configured to the second visibility map of the target view to obtain the target texture map of the target view.

In some embodiments, the target texture map obtaining module 205 is configured to shade, in a case where the first visibility map satisfies a condition, the first visibility map to obtain the target texture map of the target view; and repeatedly perform, in a case where the first visibility map does not satisfy the condition, iterative optimization processing on the first visibility map until a processed first visibility map satisfies the condition, and shade a first visibility map satisfying the condition to obtain the target texture map of the target view. The iterative optimization process includes shading the first visibility map to obtain a first texture map of the target view, segmenting the first texture map to obtain segmentation regions; and performing quality improvement processing on a region of the first visibility map corresponding to a respective one of the segmentation regions of the first texture map, to obtain the processed first visibility map.

In some embodiments, the condition is one of: a noise region and/or a transition zone of the first visibility map has an area smaller than a preset threshold, a number of iterations reach a preset number, or N comparison results are all within a preset range, where the comparison result is a difference between a first visibility map obtained at present and a visibility map obtained in a previous time, and N is an integer greater than 0.

In some embodiments, the region segmenting module 202 is configured to segment, according to a preset first number of segmentation regions, the initial visibility map to obtain the segmentation regions and segment, according to a preset second number of segmentation regions, the first texture map to obtain the segmentation regions. The first number is less than the second number.

In some embodiments, the identifying module 203 is configured to cluster pixel values of pixels in the segmentation region of the initial visibility map to at least obtain: a pixel number of a first category of pixels and a pixel number of a second category of pixels, and a pixel value of a cluster centroid of the first category of pixels and a pixel value of a cluster centroid of the second category of pixels; and the identifying module 203 is configured to determine the target pixels in the segmentation region according to one of: a relationship between the pixel number of the first category of pixels and the pixel number of the second category of pixels, or a relationship between the pixel value of the cluster centroid of the first category of pixels and the pixel value of the cluster centroid of the second category of pixels.

In some embodiments, the identifying module 203 is configured to map pixel values of pixels in the initial visibility map to a specific interval to obtain a standard visibility map; take the segmentation regions of the initial visibility map as segmentation regions of the standard visibility map, and cluster pixels in the segmentation region of the standard visibility map to at least obtain: a pixel number of a first category of pixels and a pixel number of a second category of pixels, and a pixel value of a cluster centroid of the first category of pixels and a pixel value of a cluster centroid of the second category of pixels. The identifying module 203 is further configured to determine target pixels in the segmentation region of the standard visibility map according to one of: a relationship between the pixel number of the first category of pixels and the pixel number of the second category of pixels, or a relationship between the pixel value of the cluster centroid of the first category of pixels and the pixel value of the cluster centroid of the second category of pixels. Accordingly, the updating module 204 is configured to update pixel values of target pixels in the segmentation region of the standard visibility map to obtain an updated standard visibility map; and inversely map, according to a mapping relationship between the initial visibility map and the standard visibility map, pixel values of pixels in the updated standard visibility map to obtain the first visibility map.

In some embodiments, the identifying module 203 is further configured to cluster the pixels in the segmentation region of the standard visibility map to further determine non-target pixels in the segmentation region. Accordingly, the updating module 204 is configured to determine, according to pixel values of the non-target pixels in the segmentation region of the standard visibility map, a pixel replacement value of the segmentation region; and update the pixel values of the target pixels in the segmentation region of the standard visibility map to the pixel replacement value of the segmentation region, to obtain the updated standard visibility map.

In some embodiments, the updating module 204 is configured to determine a pixel value of a cluster centroid of the non-target pixels in the segmentation region of the standard visibility map as the pixel replacement value of the segmentation region.

In some embodiments, the identifying module 203 is configured to determine the second category of pixels as the target pixels in the segmentation region in a case where a first operation result of subtracting the pixel value of the cluster centroid of the second category of pixels from the pixel value of the cluster centroid of the first category of pixels is greater than or equal to a first threshold and a second operation result of dividing the pixel number of the first category of pixels by the pixel number of the second category of pixels is greater than or equal to a second threshold; and determine the first category of pixels as the target pixels in the segmentation region in a case where a third operation result of subtracting the pixel value of the cluster centroid of the first category of pixels from the pixel value of the cluster centroid of the second category of pixels is greater than or equal to the first threshold and a fourth operation result of dividing the pixel number of the second category of pixels by the pixel number of the first category of pixels is greater than or equal to the second threshold.

In some embodiments, the identifying module 203 is further configured to determine that both the first category of pixels and the second category of pixels are the non-target pixels in the segmentation region in a case where the first operation result is less than the first threshold or the second operation result is less than the second threshold, and the third operation result is less than the first threshold or the fourth operation result is less than the second threshold.

In some embodiments, the first threshold is within a range of [25,33], and the second threshold is within a range of [5,10].

The description of the above device embodiments is similar to the description of the above method embodiments and the above device embodiments have similar beneficial effect as the method embodiments. Technical details not disclosed in the device embodiments of the present disclosure are understood with reference to the description of the method embodiments of the present disclosure.

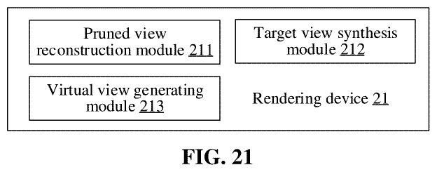

Embodiments of the present disclosure provide a rendering device. FIG. 21 shows the schematic structural diagram of the rendering device according to an embodiment of the present disclosure. As shown in FIG. 21, the device 21 includes a pruned view reconstruction module 211, a virtual view generating module 212 and a target view synthesis module 213. The pruned view reconstruction module 211 is configured to perform pruned view reconstruction on an atlas of a depth map of a source view to obtain the depth map of the source view. The virtual view generating module 212 is configured to perform operations in the method for generating a virtual view on the depth map of the source view to obtain a target texture map of a target view. The target view synthesis module 213 is configured to generate a target viewport of the target view according to the target texture map of the target view.

The description of the above device embodiments is similar to the description of the above method embodiments and the above device embodiments have similar beneficial effect as the method embodiments. Technical details not disclosed in the device embodiments of the present disclosure are understood with reference to the description of the method embodiments of the present disclosure.

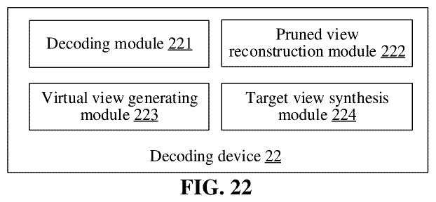

Embodiments of the present disclosure provide a decoding device. FIG. 22 is a schematic structural diagram of a decoding device according to an embodiment of the present disclosure. As shown in FIG. 22, the device 22 includes a decoding module 221, a pruned view reconstruction module 222, a virtual view generating module 223, and a target view synthesis module 224. The decoding module 221 is configured to decode input bitstream to obtain an atlas of a depth map of a source view. The pruned view reconstruction module 222 is configured to perform pruned view reconstruction on the atlas of the depth map of the source view to obtain the depth map of the source view. The virtual view generating module 223 is configured to perform operations in the method for generating a virtual view on the depth map of the source view to obtain a target texture map of a target view. The target view synthesis module 224 is configured to generate a target viewport of the target view according to the target texture map of the target view.

The description of the above device embodiments is similar to the description of the above method embodiments and the above device embodiments have similar beneficial effect as the method embodiments. Technical details not disclosed in the device embodiments of the present disclosure are understood with reference to the description of the method embodiments of the present disclosure.

In the embodiments of the present disclosure, if the method for generating a virtual view is realized in the form of a software function module and sold or used as an independent product, it can be stored in a computer readable storage medium. Based on such understanding, the technical solution of the present disclosure, in essence or in the form of a software product, which is stored in a storage medium, includes several instructions for making a computer device (which can be a personal computer, a server, a network device, etc.) to perform all or part of the steps of the method according to each embodiment of the present disclosure. The aforementioned storage media include: U disk, mobile hard disk, read-only memory (ROM), random access memory (RAM), disk or optical disk and other media that can store program code.

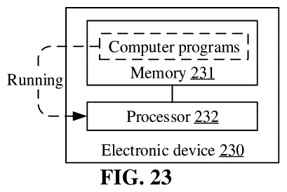

Correspondingly, embodiments of the present disclosure provide an electronic device. FIG. 23 is a schematic diagram of a hardware entity of an electronic device according to an embodiment of the present disclosure. As shown in FIG. 24, the electronic device 230 includes a memory 231 storing computer programs executable on the processor 232 and a processor 232, when the processor 232 executes the programs, the operations of the method provided in the above embodiments are implemented.

It should be noted that the memory 231 is configured to store instructions and applications executable by the processor 232, and may also cache data (e.g. image data, audio data, voice communication data and video communication data) to be processed or already processed by various modules in the processor 232 and the electronic device 230, and may be implemented by a FLASH or a random access memory (RAM).

Correspondingly, embodiments of the present disclosure provides a computer-readable storage medium having stored thereon computer programs that, when executed by a processor, cause the processor to implement the method for generating a virtual view. Embodiments of the disclosure provide a decoder configured to implement the decoding method provided by the embodiments of the disclosure. Embodiments of the disclosure provide a rendering device configured to implement the rendering method provided by the embodiments of the disclosure. Embodiments of the disclosure provide a view weighting synthesizer, configured to implement the method provided by the embodiments of the disclosure.

It should be noted here that the above descriptions of the embodiments of the electronic device, storage medium, decoder, rendering device and view weighting synthesizer are similar to those of the above method embodiments and have similar beneficial effects as those of the method embodiments. Technical details not disclosed in embodiments of the electronic device, storage medium, decoder, rendering device, and view weighting synthesizer of the present disclosure may be understood with reference to the description of the method embodiments of the present disclosure.

It should be understood that references to “one embodiment” or “an embodiment” or “some embodiments” or “other embodiments” throughout the specification mean that particular features, structures, or characteristics related to the embodiments are included in at least one embodiment of the present disclosure. Thus, the words “in one embodiment” or “in an embodiment” or “in some embodiments” or “in other embodiments” appearing throughout the specification do not necessarily refer to the same embodiment. Furthermore, these particular features, structures or characteristics may be incorporated in one or more embodiments in any suitable manner. It should be understood that, in various embodiments of the present disclosure, the sequence numbers of the above processes does not mean the sequence of execution, and the sequence of execution of each process should be determined according to its functions and internal logic, and should not constitute any limitation on the implementation process of the embodiments of the present disclosure. The above embodiments of the present disclosure are numbered only for description, and do not represent advantages or disadvantages of the embodiments.

It should be noted that in this context, the terms “include,” “contain” or any other variant thereof are intended to cover non-exclusive inclusions such that a process, method, article, or apparatus that includes a series of elements includes not only those elements, but also other elements not specifically listed, or elements inherent to such a process, method, article, or apparatus. Without further limitation, the element defined by the statement “including a . . . ” does not rule out there are other identical elements in the process, method, article, or apparatus that includes the element.

In the several embodiments provided in the present disclosure, it should be understood that the disclosed apparatus and method may be implemented in other ways. The device embodiments described above are merely illustrative. For example, the unit division is merely a logical function division, and there may be another division mode in actual implementation, for example, multiple units or components may be combined, or may be integrated into another system, or some features may be ignored or not performed. In addition, the components shown or discussed may be coupled, or directly coupled, or communicatively connected to each other through some interfaces, or indirectly coupled or communicatively connected to a device or unit, which may be electrical, mechanical, or other forms.

The above unit described as the separating component may or may not be physically separated, and the component displayed as the unit may or may not be a physical unit, may be located in one place or distributed across multiple network units. Some or all of these units may be selected according to actual needs to achieve the objective of the solution of this embodiment.

In addition, all the functional units in various embodiments of the present disclosure may be integrated in one processing unit, or each unit may be separately used as one unit, or two or more units may be integrated in one unit. The above integrated units may be implemented in the form of hardware or hardware plus software functional units.

A person of ordinary skill in the art may understand that all or part of the steps of the above method embodiments may be implemented by a program instructing relevant hardware, the above programs may be stored in a computer readable storage medium, and when executed, the programs perform the operations of the above method embodiments. The above storage medium includes various media that may store program codes, such as a removable storage device, a read only memory (ROM), a magnetic disk, or an optical disc.

Alternatively, the integrated units of the embodiments of the present disclosure may be stored in a computer-readable storage medium when they are implemented as software functional modules and sold or used as independent products. According to such an understanding, the technical solutions in the embodiments of the present disclosure essentially or the part contributing to the related art may be embodied in the form of a software product stored in a storage medium including several instructions for causing a computer device (which may be a personal computer, a server, a network device, or the like) to perform all or part of the methods described in the embodiments of the present disclosure. The above storage medium includes medium that may store program code, such as a removable storage device, a ROM, a magnetic disk, an optical disc.

The methods disclosed in the method embodiments provided in this disclosure can be arbitrarily combined without conflict to obtain new method embodiments. The features disclosed in the product embodiments provided in this disclosure can be arbitrarily combined without conflict to obtain new product embodiments. The features disclosed in the method or device embodiments provided in this disclosure can be arbitrarily combined without conflict to obtain new method embodiments or apparatus embodiments.

What described above are merely implementations in the embodiments of the present disclosure, but the protection scope of the embodiments of the present disclosure is not limited thereto. Any change or replacement readily figured out by a person skilled in the art within the technical scope disclosed in the embodiments of the present disclosure shall fall within the protection scope of the embodiments of the present disclosure. Therefore, the protection scope of the embodiments of the present disclosure shall be subject to the protection scope of the claims.

1. A method for generating a virtual view, comprising:
generating an initial visibility map of a target view according to a depth map of a source view;
segmenting the initial visibility map to obtain segmentation regions;
identifying target pixels in the segmentation region according to a quantity relationship of two categories of pixels in the segmentation region of the initial visibility map;
updating pixel values of the target pixels in the segmentation region of the initial visibility map to obtain a first visibility map of the target view; and
processing the first visibility map of the target view to obtain a target texture map of the target view.

2. The method of claim 1, wherein processing the first visibility map of the target view to obtain the target texture map of the target view comprises:
shading the first visibility map of the target view to obtain the target texture map of the target view.

3. The method of claim 1, wherein processing the first visibility map of the target view to obtain the target texture map of the target view comprises:
shading the first visibility map of the target view to obtain a first texture map of the target view;
segmenting the first texture map to obtain segmentation regions;
performing quality improvement processing on a region of the first visibility map corresponding to a respective one of the segmentation regions of the first texture map, to obtain a second visibility map of the target view; and
processing the second visibility map of the target view to obtain the target texture map of the target view.

4. The method of claim 3, wherein processing the second visibility map of the target view to obtain the target texture map of the target view comprises:
shading the second visibility map of the target view to obtain the target texture map of the target view.

5. The method of claim 1, wherein processing the first visibility map of the target view to obtain the target texture map of the target view comprises:
shading, in a case where the first visibility map satisfies a condition, the first visibility map to obtain the target texture map of the target view; and
repeatedly performing, in a case where the first visibility map does not satisfy the condition, iterative optimization processing on the first visibility map until a processed first visibility map satisfies the condition, and shading a first visibility map satisfying the condition to obtain the target texture map of the target view,
wherein the iterative optimization process comprises:
shading the first visibility map to obtain a first texture map of the target view;
segmenting the first texture map to obtain segmentation regions; and
performing quality improvement processing on a region of the first visibility map corresponding to a respective one of the segmentation regions of the first texture map, to obtain the processed first visibility map.

6. The method of claim 5, wherein the condition is one of:
a noise region and/or a transition zone of the first visibility map has an area smaller than a preset threshold, a number of iterations reach a preset number, or N comparison results are all within a preset range, wherein the comparison result is a difference between a first visibility map obtained at present and a visibility map obtained in a previous time, and N is an integer greater than 0.

7. The method of claim 3, wherein segmenting the initial visibility map to obtain the segmentation regions comprises: segmenting, according to a preset first number of segmentation regions, the initial visibility map to obtain the segmentation regions,
wherein segmenting the first texture map to obtain the segmentation regions comprises: segmenting, according to a preset second number of segmentation regions, the first texture map to obtain the segmentation regions,
wherein the first number is less than the second number.

8. The method of claim 1, wherein identifying the target pixels in the segmentation region according to the quantity relationship of the two categories of pixels in the segmentation region of the initial visibility map comprises:
clustering pixel values of pixels in the segmentation region of the initial visibility map to at least obtain: a pixel number of a first category of pixels and a pixel number of a second category of pixels, and a pixel value of a cluster centroid of the first category of pixels and a pixel value of a cluster centroid of the second category of pixels; and
determining the target pixels in the segmentation region according to one of: a relationship between the pixel number of the first category of pixels and the pixel number of the second category of pixels, or a relationship between the pixel value of the cluster centroid of the first category of pixels and the pixel value of the cluster centroid of the second category of pixels.

9. The method of claim 8, wherein clustering the pixel values of the pixels in the segmentation region of the initial visibility map to at least obtain: the pixel number of the first category of pixels and the pixel number of the second category of pixels, and the pixel value of the cluster centroid of the first category of pixels and the pixel value of the cluster centroid of the second category of pixels comprises:
mapping pixel values of pixels in the initial visibility map to a specific interval to obtain a standard visibility map;
taking the segmentation regions of the initial visibility map as segmentation regions of the standard visibility map, clustering pixels in the segmentation region of the standard visibility map to at least obtain: a pixel number of a first category of pixels and a pixel number of a second category of pixels, and a pixel value of a cluster centroid of the first category of pixels and a pixel value of a cluster centroid of the second category of pixels, wherein determining the target pixels in the segmentation region according to one of:
the relationship between the pixel number of the first category of pixels and the pixel number of the second category of pixels, or the relationship between the pixel value of the cluster centroid of the first category of pixels and the pixel value of the cluster centroid of the second category of pixels comprises:
determining target pixels in the segmentation region of the standard visibility map according to one of: a relationship between the pixel number of the first category of pixels and the pixel number of the second category of pixels, or a relationship between the pixel value of the cluster centroid of the first category of pixels and the pixel value of the cluster centroid of the second category of pixels; and
wherein updating the pixel values of the target pixels in the segmentation region of the initial visibility map to obtain the first visibility map of the target view comprises:
updating pixel values of target pixels in the segmentation region of the standard visibility map to obtain an updated standard visibility map; and
inversely mapping, according to a mapping relationship between the initial visibility map and the standard visibility map, pixel values of pixels in the updated standard visibility map to obtain the first visibility map.

10. The method of claim 9, further comprising: clustering the pixels in the segmentation region of the standard visibility map to further determine non-target pixels in the segmentation region,
wherein updating the pixel values of the target pixels in the segmentation region of the standard visibility map to obtain the updated standard visibility map comprises:
determining, according to pixel values of the non-target pixels in the segmentation region of the standard visibility map, a pixel replacement value of the segmentation region; and
updating the pixel values of the target pixels in the segmentation region of the standard visibility map to the pixel replacement value of the segmentation region, to obtain the updated standard visibility map.

11. The method of claim 10, wherein determining, according to the pixel values of the non-target pixels in the segmentation region of the standard visibility map, the pixel replacement value of the segmentation region comprises:
determining a pixel value of a cluster centroid of the non-target pixels in the segmentation region of the standard visibility map as the pixel replacement value of the segmentation region.

12. The method of claim 9, wherein determining the target pixels in the segmentation region of the standard visibility map according to one of: the relationship between the pixel number of the first category of pixels and the pixel number of the second category of pixels, or the relationship between the pixel value of the cluster centroid of the first category of pixels and the pixel value of the cluster centroid of the second category of pixels comprises:
in a case where a first operation result of subtracting the pixel value of the cluster centroid of the second category of pixels from the pixel value of the cluster centroid of the first category of pixels is greater than or equal to a first threshold and a second operation result of dividing the pixel number of the first category of pixels by the pixel number of the second category of pixels is greater than or equal to a second threshold, determining the second category of pixels as the target pixels in the segmentation region; and
in a case where a third operation result of subtracting the pixel value of the cluster centroid of the first category of pixels from the pixel value of the cluster centroid of the second category of pixels is greater than or equal to the first threshold and a fourth operation result of dividing the pixel number of the second category of pixels by the pixel number of the first category of pixels is greater than or equal to the second threshold, determining the first category of pixels as the target pixels in the segmentation region.

13. The method of claim 12, wherein clustering the pixels in the segmentation region of the standard visibility map to further determine the non-target pixels in the segmentation region comprises:
in a case where the first operation result is less than the first threshold or the second operation result is less than the second threshold, and the third operation result is less than the first threshold or the fourth operation result is less than the second threshold, determining that both the first category of pixels and the second category of pixels are the non-target pixels in the segmentation region.

14. The method of claim 13, wherein the first threshold is within a range of [25,33], and the second threshold is within a range of [5,10].

15. A rendering method, comprising:
performing pruned view reconstruction on an atlas of a depth map of a source view to obtain the depth map of the source view;
performing operations in the method of claim 1 on the depth map of the source view to obtain a target texture map of a target view; and
generating a target viewport of the target view according to the target texture map of the target view.

16. A decoding method, comprising:
decoding input bitstream to obtain an atlas of a depth map of a source view;
performing pruned view reconstruction on the atlas of the depth map of the source view to obtain the depth map of the source view;
performing operations in the method of claim 1 on the depth map of the source view to obtain a target texture map of a target view; and
generating a target viewport of the target view according to the target texture map of the target view.

17. A device for generating a virtual view, comprising: a memory and a processor, wherein the memory is configured to store computer instructions executable on the processor, and the processor is configured to implement the method of claim 1 when executing the computer instructions.

18. A rendering device, comprising: a memory and a processor, wherein the memory is configured to store computer instructions executable on the processor, and the processor is configured to implement the method of claim 15 when executing the computer instructions.

19. A decoding device, comprising: a memory and a processor, wherein the memory is configured to store computer instructions executable on the processor, and the processor is configured to implement the method of claim 16 when executing the computer instructions.

20. A View Weighting Synthesizer (VWS) configured to implement the method of claim 1.
